(19) United States
(12) Patent Application Publication
(10) Pub. No.: US 2006/0005358 A1
(43) Pub. Date: Jan. 12, 2006

(54) Handle for a Handheld Working Tool

(75) Inventors: Ralf-Rainer Kemmler, Schwaikheim (DE); Bertram Kandziora, Waiblingen (DE)

Correspondence Address: GUDRUN E. HUCKETT DRAUDT, LONSSTR. 53, WUPPERTAL, 42289, DE

(73) Assignee: ANDREAS STIHL AG & CO. KG, Waiblingen (DE)

(21) Appl. No.: 11/160,299

(22) Filed: Jun. 17, 2005

(30) Foreign Application Priority Data
Jun. 22, 2004 (DE) 102004030157.3

(51) Int. Cl. B25G 1/10

(52) U.S. Cl. 16/430

(57) ABSTRACT

A handle of a handheld working tool has a handle pipe reinforced by at least one reinforcement element locally arranged on the handle pipe at a location of high dynamic vibration-caused deformation energy. The handle pipe and the reinforcement element are made of plastic material. A laminate that is made of fiber-reinforced plastic material can be used for making the handle.

### BACKGROUND OF THE INVENTION

The invention relates to a handle of a handheld working tool, such as a motor chain saw or the like, comprising a handle pipe. The invention further relates to a working tool comprising such a handle.

When operating a handheld working tool (power tool), such as a motor chainsaw, a trimmer or the like, mechanical vibrations occur that can be caused by the running of a drive motor or by the driven cutting tool. The working tool (power tool) is held by a handle and guided during operation of the tool by means of the handle. The mass of the working tool forms together with the elastically deformable handle a vibratory system that can be excited by the exciting vibrations of the motor or the cutting tool. These vibrations can be felt by the operator's hand that grips the handle and guides the tool. Excessive vibrations can cause the operator to experience untimely fatigue or can lead to an unsatisfactory work result.

Numerous designs of vibration damping measures are known with which a damping connection of the handle on the housing of the working tool (power tool) is provided. The vibrations that can be felt at the handle are to be dampened and reduced in this way. Japanese patent document 09037635 A discloses a handle of a handheld tea harvesting machine wherein the handle has a U-shape. The free legs of the U-shape are made of carbon fiber pipes that are connected to one another by means of a curved aluminum pipe. For damping the vibrations that occur, the curved aluminum pipe is covered with a vibration-damping hose.

### SUMMARY OF THE INVENTION

It is an object of the present invention to further develop a handle of a handheld working tool such that in operation of the working tool a reduced vibration level occurs at the handle.

In accordance with the present invention, this is achieved in that the handle pipe, at locations of high dynamic vibration-caused deformation energy, is reinforced by at least one reinforcement element locally arranged on the handle pipe.

It is a further object of the present invention to provide a working tool with reduced operating vibrations on the handle. In accordance with the present invention, this is achieved in that the working tool comprises a handle having a handle pipe that, at locations of high dynamic vibration-caused deformation energy, is reinforced by at least one reinforcement element locally arranged on the handle pipe.

A handle of a hand-held working tool is proposed in which the handle pipe, at locations of high potential vibration-caused deformation energy, is reinforced by at least one reinforcement element locally arranged on the handle pipe. When vibration excitation occurs, on the handle pipe a dynamic deformation line with antinodes and nodes is generated at the handle pipe. In these areas, an increased deformation energy by bending strain, lateral force deformation, and torsion is generated. The arrangement of one or several reinforcement elements in these areas leads to a targeted reinforcement in precisely these areas while in the areas of reduced deformation energy the additional mass of reinforcement elements is not required. The targeted reinforcement leads to an increase of the resonant frequency wherein the lack of additional reinforcement element having corresponding masses in the area of reduced deformation energy leads to an additional increase with regard to the resonant frequency of the vibratory system. The vibration system comprised of the working tool (power tool) and its handle has as a whole a minimal mass with high stiffness and, as a result of this, a high resonant frequency. The resonant frequency can be adjusted in a targeted way such that it is located remote from a dominant excitation frequency in operation of the working tool (power tool). A targeted detuning of the system is possible such that the vibration excitation by the drive motor and/or by the cutting tool leads to no or at most a minimal dynamic excess at the handle. This handle has a minimal vibration level.

The reinforcement of the handle pipe is advantageously configured such that the resonant frequency of the vibration system comprising the working tool (power tool) and the handle is outside of an excitation frequency range of the working tool under operating conditions and, in particular, above the operating speed of a drive motor of the working tool. During operation of the working tool (power tool), for example, under full load conditions, resonance vibrations at the handle are reliably prevented.

In a preferred embodiment of the invention, the handle pipe and/or the reinforcement element is made of plastic material. For this purpose, expediently a laminate of fiber-reinforced plastic material or a thermoplastic plastic material is provided. By laminating, extruding, injection molding or a combination thereof, essentially any appropriate matching shape can be obtained with which with minimal weight, local reinforcements having high local shape rigidity and material stiffness can be obtained. With a suitable laminate structure, a high specific stiffness of the material can be obtained. Relative to the weight of the handle pipe, a high bending stiffness or shear stiffness can be achieved as result of which a detuning of the vibration system above the operating states can be obtained. Optionally, a high over-critical resonant frequency of the vibration system can be adjusted. In an advantageous embodiment, the laminate contains carbon fibers and is, in particular, comprised of a plastic material containing exclusively carbon fibers. This results in a beneficial ratio of stiffness to mass with a correspondingly high resonant frequency.

In an expedient embodiment, the reinforcement element is a stringer extending in the direction of a pipe axis of the handle pipe. When providing an appropriate arrangement of one or several stringers, the longitudinal stiffness and bending stiffness of the handle pipe can be adjusted effectively. In particular, several stringers are distributed about the circumference of the handle pipe such that the handle pipe in the direction of increased dynamic bending load is stiffer than transversely to said direction. A targeted reinforcement in the bending direction is possible with only minimal mass growth.

In an advantageous variant, the reinforcement element is a rib member that extends transversely to the pipe axis of the handle pipe. By means of an arrangement of one or several rib members, the cross-section of the handle pipe can be effectively reinforced and flattening of the cross-section under operating loads can be prevented. In particular in the case of a system of stringers and rib members, the rib members enhance the effectiveness of the stringers. For example, in the curved areas of the handle pipe, longitudinal forces in the stringers lead to loading of the pipe cross-section in a transverse direction or radial direction. The reinforcement by means of rib members prevents flattening of the cross-section. The stringers cannot yield in the radial direction and therefore maintain their predetermined stiffness.

In another expedient embodiment, the location of increased deformation energy is provided with a reinforcement element distributed uniformly about the circumference of the handle pipe. An areal support action without local stress peaks is provided. The reinforcement element requires only a minimal wall thickness; this prevents an excessive cross-sectional change of the handle pipe.

The reinforcement element is advantageously arranged externally on the handle pipe so that a significantly increased geometrical moment of inertia can be obtained with only minimal mass increase. This results in a correspondingly distinctive reinforcement action with increase of the resonant frequency of the vibration system. By means of its shape, the reinforcement element arranged on the exterior can also contribute to improved grip.

Alternatively, it can also be expedient to arrange the reinforcement element inside the handle pipe. In particular in areas of distinctive bending of the pipe axis, this provides an effective cross-sectional support action, for example, when bending a thermoplastic pipe. The outer contour of the handle pipe remains undisturbed by the reinforcement element.

An advantageously performed areal adhesive attachment of the reinforcement element on the handle pipe leads to an intimate connection that increases the strength in addition to increasing the stiffness.

It can also be expedient to integrate the reinforcement element into the handle pipe. This can be achieved, for example, by a suitable laminate construction with which the reinforcement element is embedded on both sides by laminate layers. When performing injection molding, a separate reinforcement element can also be incorporated by injection molding or can be formed as an integral component on the exterior or interior of the pipe wall.

In an advantageous embodiment, the handle pipe has distinctly curved sections as well as fastening sections that are reinforced by the corresponding reinforcement elements, respectively. It was found that the aforementioned areas are subject to high dynamic bending strain, lateral force loads, and torsional loads; the resonant frequency of the vibration system can be raised in a targeted fashion by a targeted reinforcement in these areas. The further areas of the handle pipe can remain free of reinforcement. Additional masses in this area as well as thickening of the cross-section therefore are not required. The handle pipe can maintain its ergonomically beneficial basic cross-section in the remaining areas. In particular, a reinforcement of the fastening section is extended past the fastening section in the direction of the further course of the handle pipe. This preferred embodiment takes into account that the immediate area of the fastening section is loaded excessively by screwing forces or the like while the neighboring area is loaded excessively by bending strain, lateral force loads and torsional loads. The area of increased load is therefore appropriately reinforced in a targeted way.

### BRIEF DESCRIPTION OF THE DRAWING

FIG. 1 is a perspective general illustration of a handheld working tool embodied as a motor chainsaw and comprising a handle pipe.

FIG. 2 is a side view of the handle pipe according to FIG. 1 under dynamic operating load.

FIG. 3 is an end view of the handle pipe according to FIG. 2 with locally arranged rib members and stringers.

FIG. 4 is a schematic illustration of the cross-section of the handle pipe according to FIGS. 2 and 3 in the area of the rib members and stringers.

FIG. 5 is a schematic cross-sectional illustration of the handle pipe with a reinforcement element integrated into the handle pipe.

FIG. 6 shows a variant with reinforcement element arranged on the interior side of the handle pipe.

FIG. 7 is another variant with the reinforcement element arranged on the exterior side.

FIG. 8 is a schematic detail view of the reinforced gripping area having a reinforcement fabric arranged on the exterior side.

FIG. 9 is a variant of the arrangement according to FIG. 8 with a shaped non-woven as a reinforcement element arranged on the exterior side.

FIG. 10 is a further embodiment with an exterior shaped part having holes or openings.

FIG. 11 is a variant showing a reinforcement grid on the exterior side.

FIG. 12 shows another embodiment according to the present invention with individual reinforcement elements arranged on the interior side.

### DESCRIPTION OF THE PREFERRED EMBODIMENTS

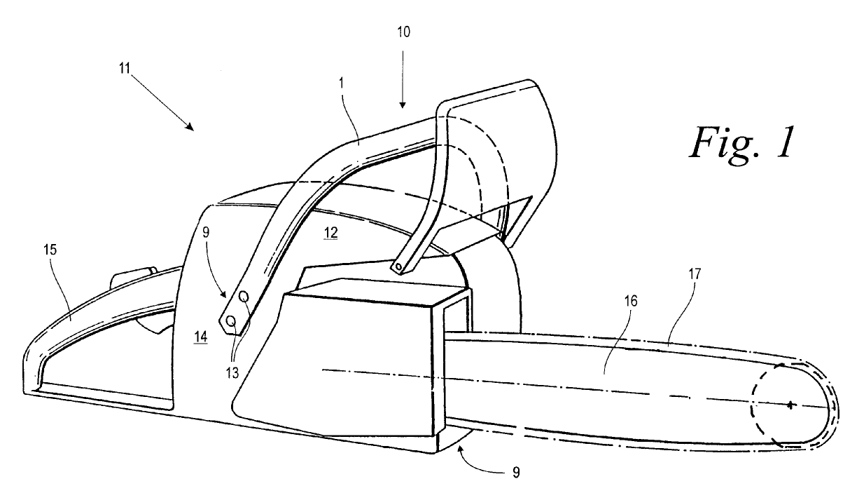

FIG. 1 shows a perspective illustration of a handheld working tool 11 shown in an exemplary embodiment as a motor chainsaw. The working tool 11 has a motor housing 14 in which a drive motor 12, not shown in detail, is arranged. A guide bar 16 projects from the motor housing 14; a saw chain 17 driven by the drive motor 12 is guided in circulation about the guide bar 16. A rear handle 15 is arranged at the rear area of the motor housing 14 opposite the guide bar 16. A front handle 10 comprises a handle pipe or handle tube 1 that partially surrounds the motor housing 14 near the center of gravity. The handle pipe 1 has two fastening sections 9 arranged at a lateral surface of the motor housing 14 and in the area of the bottom of the working tool 11; the handle pipe 1 is attached by means of screws 13 with the fastening sections to the motor housing 14.

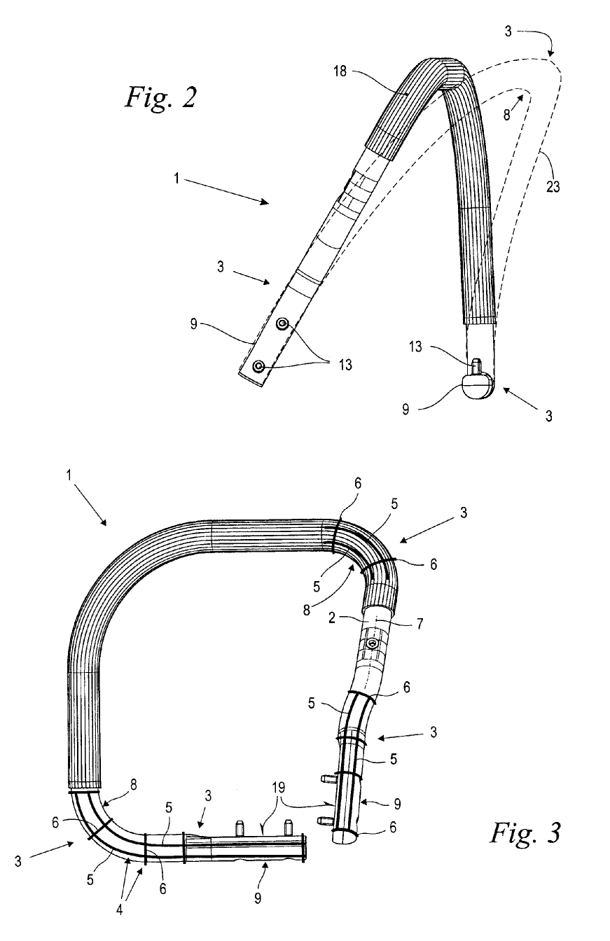

FIG. 2 shows in a side view details of the handle pipe 1 according to FIG. 1. The handle pipe 1 is covered by a grip hose 18 in the gripping area. The handle pipe 1 is held in operation in the area of the grip hose 18 near the center of gravity of the working tool 11 (FIG. 1); a dynamic vibrating deformation of the handle pipe 1 occurs by vibration excitation caused by the drive motor 12 and/or by the saw chain 17 (FIG. 1). A first basic shape of the vibrating deformation of the handle pipe 1 is illustrated by dashed lines 23 (FIG. 2) wherein the handle pipe 1 has various locations 3 of high dynamic vibration-caused deformation energy. Such locations 3 are generated in the distinctly curved sections 8 and in the area of the fastening sections 9 and screws 13 of the handle pipe 1.

FIG. 3 shows in a front view the handle pipe 1 according to FIG. 2. As illustrated in FIG. 3, the handle pipe 1 is reinforced by means of reinforcement elements 4 arranged locally on the handle pipe 1 at the locations 3 of high dynamic vibration-caused deformation energy, respectively. These locations 3 are formed by the two fastening sections 9 and the two distinctly curved sections 8. The fastening sections 9 extend across an area providing contact surfaces 19 that rest in the mounted state on the motor housing 14 (FIG. 1).

The reinforcement elements are reinforced by means of a system of stringers 5 and rib members 6 wherein the stringers 5 and the rib members 6 are arranged on the exterior of the handle pipe 1 and are areally glued onto the handle pipe 1. The reinforcement by means of rib members 6 and stringers 5 extends past the fastening sections 9 in the direction of the further course of the handle pipe 1, wherein the stringers 5 of the lower fastening section 9 pass through the adjoining curved area 8. The stringers 5 extend in the direction of the pipe axis 7 of the handle pipe 1 while the rib members 6 are arranged transversely to the pipe axis 7 of the handle pipe 1. The handle pipe 1 is locally reinforced at the locations 3 of high dynamic vibration-caused deformation energy by means of the reinforcement elements 4 while the remaining areas of the handle pipe 1 are embodied by the handle pipe 1 free of reinforcements.

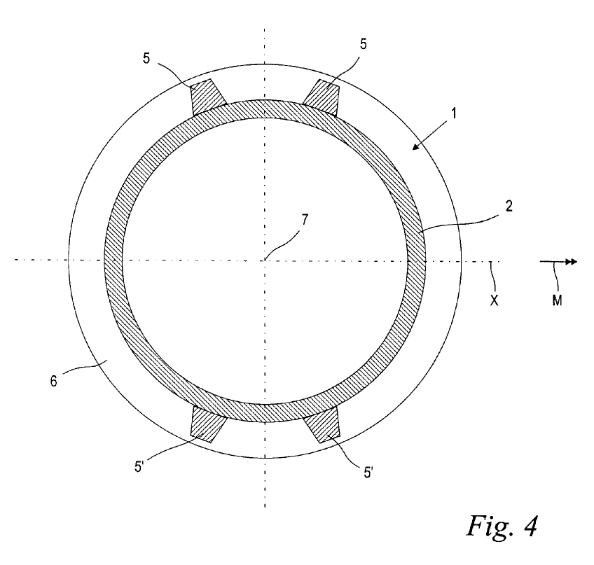

FIG. 4 shows in a schematic illustration a cross-section of the handle pipe 1 according to FIG. 3. The rib member 6 is embodied as an annular member arranged externally on the handle pipe 1. There are a total of four stringers 5, 5′ extending in the longitudinal direction of the pipe axis 7; the paired stringers 5 or 5′ are positioned closely adjacent to one another. By means of the paired arrangement of the stringers 5 or 5′, an increased bending stiffness of the handle pipe 1 is provided under a load of a bending moment M about a cross-sectional axis X which bending stiffness is greater than a bending stiffness perpendicular thereto. The handle pipe 1 as well as the externally arranged stringers 5 and rib members 6 are manufactured of a plastic material. In the illustrated embodiment, a laminate 2 of fiber-reinforced plastic material is provided for the handle pipe 1, the stringers 5 and the rib members 6, wherein the fiber-reinforced plastic material in the illustrated embodiment contains exclusively carbon fibers. It is also possible to employ a mixed laminate or a laminate of a single type with other fiber materials such as glass fibers and/or aramid fibers. It can be expedient to provide for the laminate 2 of the handle pipe 1 a woven or knit fiber hose while for the laminate 2 of the stringers 5 and the rib members 6 preferably unidirectional fiber layers are used. The handle pipe 1 can also be an aluminum pipe or the like. It can be expedient to manufacture the handle pipe 1 and/or the reinforcement elements 4 (FIG. 3), embodied in this embodiment in an exemplary fashion as stringers 5 and rib members 6, of a thermoplastic material with or without fiber proportion.

The reinforcement of the handle pipe 1 according to FIGS. 1 through 4 is configured such that the resonant frequency of the vibration system comprised of working tool 11 and handle 10 (FIG. 1) is, for example, approximately 230 Hz. The operating speed of the drive motor 12 according to FIG. 1 under full load and with the saw chain 17 immersed in the material to be cut corresponds to an excitation frequency of approximately 200 Hz wherein the resonant frequency of the vibration system of approximately 230 Hz is above the operating speed or the excitation frequency of the drive motor 12.

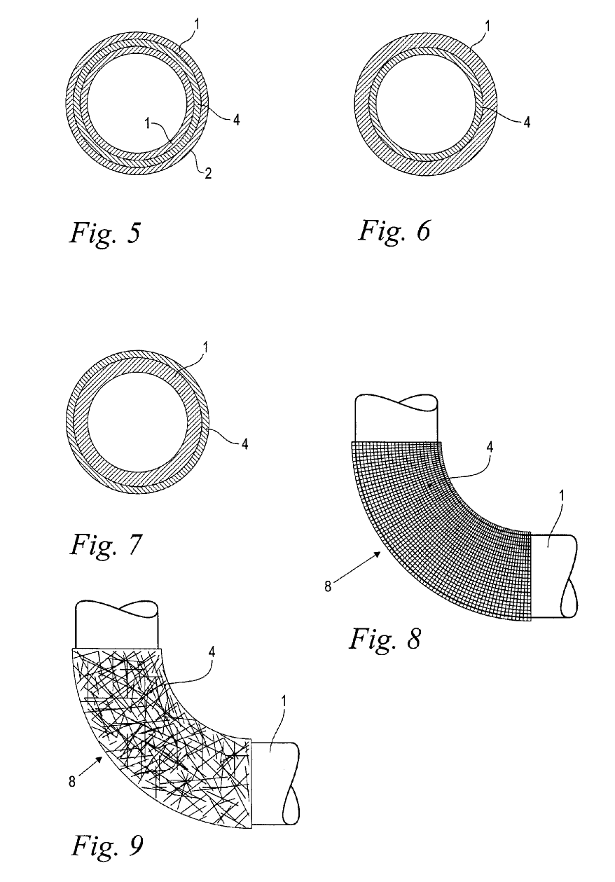

In the FIGS. 5 to 7, the handle pipe 1 is shown in a cross-sectional illustration of its reinforced area. In the embodiment according to FIG. 5, the reinforcement element 4 is integrated such into the handle pipe 1 that it is enclosed at the inner side and the outer side by the plastic material of the handle pipe 1. In an exemplary fashion, a configuration as a laminate 2 has been selected in which the reinforcement element 4 is embodied as an additional laminate layer that is centrally arranged and distributed about the entire circumference. It can also be expedient to arrange the reinforcement element 4 as an additional laminate layer only in sections in relation to the circumference, similar to the arrangement of a stringer 5 (FIG. 4). In a further advantageous variant the handle pipe 1 is an injection-molded part in which the integrated reinforcement element 4 is embedded by injection molding in the thermoplastic material of the handle pipe 1.

In the embodiment according to FIG. 6, the reinforcement element 4 is arranged at the inner side of the handle pipe 1 while in the embodiment according to FIG. 7 the reinforcement element 4 is arranged externally on the handle pipe 1. Instead of the illustrated embodiment of the circumferentially continuously extending reinforcement element 4 in the circumferential direction, a discontinuous arrangement can also be expedient. It can also be advantageous to employ in any suitable combination with one another integrated interior and exterior arrangements of reinforcement elements 4.

FIGS. 8-12 show in schematic detail illustrations different embodiments of the handle pipe 1 according to the invention, respectively, in the area of a distinctly curved section 8 with a reinforcement element 4 provided thereat. With regard to these features and reference numerals, the embodiments according to FIGS. 8 to 12 are identical relative to one another. Corresponding embodiments can also be expedient for the fastening section 9 (FIG. 3) or other suitable reinforcement locations at locations 3 of high dynamic vibration-caused deformation energy (FIGS. 2 and 3).

In the embodiment according to FIG. 8, the reinforcement element 4 is formed by a reinforcement fabric distributed uniformly about the circumference of the handle pipe 1; the arrangement corresponds to the cross-sectional illustration according to FIG. 7. The fabric can be either impregnated with a resin for forming a laminate layer or can be embedded by injection molding in a thermoplastic layer. Instead of the illustrated fabric, it is also expedient to provide a knit hose of fibers or a knit material. In accordance with the embodiment of FIG. 9, it can also be advantageous to embody the reinforcement element 4 by a shaped non-woven surrounding the handle pipe 1 for forming a laminate layer.

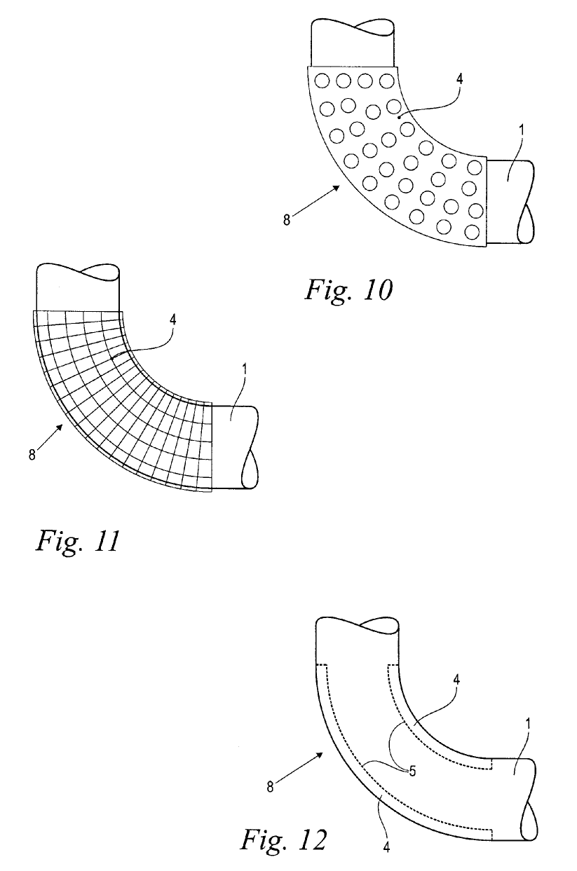

In the embodiment according to FIG. 10, the reinforcement element 4 is an injection-molded external shaped part with holes or openings. The shaped part can be glued subsequently onto the handle pipe 1 or can be injection molded by an injection molding process onto the handle pipe 1. The same holds true also for the reinforcement element according to FIG. 11 in the form of an open grid which, in addition to the reinforcement effect in analogy to the shaped part according to FIG. 10, also contributes to improving grip by means of its distinctive surface structure.

The reinforcement elements 4 illustrated in FIGS. 8 to 10 are arranged in an exemplary fashion externally on the handle pipe 1 in accordance with the cross-sectional illustration of FIG. 7 and extend uniformly distributed about the circumference of the handle pipe 1. An integrated embodiment in accordance with the cross-sectional illustration of FIG. 5 or an internal arrangement in accordance with the cross-sectional illustration of FIG. 6 can also be expedient.

In the embodiment according to FIG. 12, individual reinforcement elements 4 in the form of stringers 5 are arranged on the inner side of the handle pipe 1. An internally arranged tubular configuration of the reinforcement element 4 can also be advantageous. The different illustrated embodiments of the reinforcement elements 4 can also be combined with one another in any suitable way.

The handle pipe 1 can be made of steel or aluminum pipe; it is preferably manufactured of plastic material. In addition to the embodiment as a laminate 2 in accordance with the illustration of FIG. 4, an embodiment of a thermoplastic plastic material can be advantageous that can be extruded, drawn, blown or injection-molded. The same holds true also for the configuration of the different reinforcement elements 4. In particular in the embodiments according to FIGS. 10 and 11, the handle pipe 1 and the correlated reinforcement elements 4 can be manufactured uniformly, respectively, of identical plastic material wherein, for fulfilling visual requirements, also a uniform color can be obtained in a single working step, for example, by injection molding. In all illustrated embodiments in which the reinforcement elements 4 are arranged on the interior side or exterior side of the handle pipe 1, they are positioned directly on the corresponding pipe surface. For increasing the section modulus under bending and thus the bending stiffness, it can also be advantageous to provide a spacer between the surface of the handle pipe 1 and the reinforcement element 4, respectively.

While specific embodiments of the invention have been shown and described in detail to illustrate the inventive principles, it will be understood that the invention may be embodied otherwise without departing from such principles.

What is claimed is:

1. A handle of a handheld working tool, said handle comprising:
a handle pipe reinforced by at least one reinforcement element locally arranged on said handle pipe at a location of high dynamic vibration-caused deformation energy.

2. The handle according to claim 1, wherein said handle pipe is composed of a plastic material.

3. The handle according to claim 2, wherein said at least one reinforcement element is composed of a plastic material.

4. The handle according to claim 1, wherein at least one of said handle pipe and said at least one reinforcement element is composed of a laminate comprising fiber-reinforced plastic material.

5. The handle according to claim 4, wherein said laminate comprises carbon fibers.

6. The handle according to claim 5, wherein said laminate contains exclusively carbon fibers.

7. The handle according to claim 1, wherein at least one of said handle pipe and said at least one reinforcement element is composed of a thermoplastic plastic material.

8. The handle according to claim 1, wherein said at least one reinforcement element is a stringer extending in a direction of a pipe axis of said handle pipe.

9. The handle according to claim 8, wherein several of said at least one reinforcement element are provided and said stringers are distributed about a circumference of said handle pipe such that said handle pipe in a direction of increased dynamic bending strain is stiffer than in a direction that is perpendicular to said direction of increased dynamic bending strain.

10. The handle according to claim 1, wherein said at least one reinforcement element is a rib member extending transversely to a pipe axis of said handle pipe.

11. The handle according to claim 1, wherein several of said at least one reinforcement element are provided and comprise stringers and rib members, wherein said location of high dynamic vibration-caused deformation energy is reinforced by a system of said stringers and said rib members.

12. The handle according to claim 1, wherein said at least one reinforcement element is arranged at said location of high dynamic vibration-caused deformation energy so as to be uniformly distributed about a circumference of said handle pipe.

13. The handle according to claim 1, wherein said at least one reinforcement element is arranged on an outer side of said handle pipe or on an inner side of said handle pipe.

14. The handle according to claim 13, wherein said at least one reinforcement element is areally glued onto said inner side or said outer side of said handle pipe.

15. The handle according to claim 1, wherein said at least one reinforcement element is integrated into said handle pipe.

16. The handle according to claim 1, wherein said handle pipe has distinctly curved sections and at least one of said distinctly curved sections is reinforced by said at least one reinforcement elements.

17. The handle according to claim 1, wherein said handle pipe has a fastening section that is reinforced by said at least one reinforcement element.

18. The handle according to claim 17, wherein said at least one reinforcement element extends past said fastening section in a direction of a further course of said handle pipe.

19. A working tool comprising a handle that comprises a handle pipe reinforced by at least one reinforcement element locally arranged on said handle pipe at a location of high dynamic vibration-caused deformation energy.

20. The working tool according to claim 19, wherein said at least one reinforcement element is arranged such that a resonant frequency of a vibration system comprised of said working tool and said handle is detuned outside an excitation frequency range of said working tool under operating conditions.

21. The working tool according to claim 20, wherein said resonant frequency is above an operating speed of a drive motor of said working tool.
